(19) United States
(12) Patent Application Publication
(10) Pub. No.: US 2025/0245557 A1
(43) Pub. Date: Jul. 31, 2025

(54) SYSTEMS AND METHODS FOR APPROXIMATION OF SHAPLEY VALUES IN MEMORY-CONSTRAINED ENVIRONMENTS

(71) Applicant: JPMORGAN CHASE BANK, N.A., New York, NY (US)

(72) Inventors: Pradeep NIROULA, College Park, MD (US); Niraj KUMAR, Amsterdam (NL); Shouvanik CHAKRABARTI, Jersey City, NJ (US); Romina YALOVETZKY, Buenos Aires (NL); Marco PISTOIA, Amawalk, NY (US)

(21) Appl. No.: 18/427,467

(22) Filed: Jan. 30, 2024

(51) Int. Cl. G06N 20/00

(52) U.S. Cl. CPC G06N 20/00

(57) ABSTRACT

Systems and methods for approximation of Shapley values in memory-constrained environments are disclosed. According to an embodiment, a method may include: (1) receiving, by a training computer program executed on a training electronic device, a training dataset; (2) training, by the training computer program, a machine learning model on the training dataset; (3) deploying, by the training computer program, the machine learning model to a deployment electronic device; (4) receiving, by the deployment electronic device, an incoming data query; (5) generating, using the machine learning model, a prediction for the incoming data query; and (6) estimating, by a model explanation computer program, a Shapley value for the prediction.

### BACKGROUND OF THE INVENTION

### 1. Field of the Invention

Embodiments relate to systems and methods for approximation of Shapley values in memory-constrained environments.

### 2. Description of the Related Art

In machine learning, the goal is to learn a prediction model that takes as an input a multi-dimensional vector (also called the feature vector) and makes a prediction. The model may be trained using a training data consisting of an example and their corresponding outcome. An example may be credit card transactions that are classified as fraudulent or non-fraudulent. The features could be the geographical data, merchant, amount, etc. After training, to make predictions on a new “query,” the model is invoked with the query data.

It is also desirable to “explain” the reason(s) for the decision made by the model. One form of explanation is a Shapley value. A Shapley value is a real number assigned to each of the features. It gives a sense of how much that particular feature has influenced a prediction. A Shapley vector for a new query includes an element for each feature. Each element has a value that indicates how important that feature was towards the final prediction of the model.

Computing Shapley values is computationally expensive and typically scales exponentially with the number of features. It also requires the use of all the data in the training dataset. The size of the training set can be very large and storing all the training data is not always feasible, especially when a device has memory constraints.

### SUMMARY OF THE INVENTION

Systems and methods for approximation of Shapley values in memory-constrained environments are disclosed. According to an embodiment, a method may include: (1) receiving, by a training computer program executed on a training electronic device, a training dataset; (2) training, by the training computer program, a machine learning model on the training dataset; (3) deploying, by the training computer program, the machine learning model to a deployment electronic device; (4) receiving, by the deployment electronic device, an incoming data query; (5) generating, using the machine learning model, a prediction for the incoming data query; and (6) estimating, by a model explanation computer program, a Shapley value for the prediction.

In one embodiment, the method may also include: selecting, by the training computer program, a subset of the training dataset; and communicating, by the training computer program, the subset to the model explanation computer program, wherein the model explanation computer program estimates the Shapley value using kernel density estimation.

In one embodiment, the method may also include: clustering, by the training computer program, the training dataset into a plurality of clusters; and communicating, by the training computer program, centroids for the plurality of clusters to the deployment electronic device; wherein the model explanation computer program estimates the Shapley value by aggregating data from the plurality of clusters and weighing the plurality of clusters by similarity to the incoming query data.

In one embodiment, the method may also include: hashing, by the training computer program, the training dataset into a plurality of arrays using locality sensitive hashing; and communicating, by the training computer program, the plurality of arrays to the deployment electronic device; wherein the model explanation computer program estimates the Shapley value by using kernel density estimation.

According to another embodiment, a system may include: a training electronic device comprising a first computer processor and executing a training computer program; and a deployment electronic device comprising a second computer processor and executing a model explanation computer program; wherein the training computer program may be configured to receive a training dataset, to train a machine learning model on the training dataset, to deploy the machine learning model to a deployment electronic device; the deployment electronic device may be configured to receive an incoming data query, to generate, using the machine learning model, a prediction for the incoming data query; the model explanation computer program may be configured to estimating a Shapley value for the prediction.

In one embodiment, the training computer program may be further configured to select a subset of the training dataset and to communicate the subset to the model explanation computer program; and wherein the model explanation computer program may be further configured to estimate the Shapley value using kernel density estimation.

In one embodiment, the training computer program may be further configured to cluster the training dataset into a plurality of clusters, and to communicate centroids for the plurality of clusters to the deployment electronic device; wherein the model explanation computer program may be further configured to estimate the Shapley value by aggregating data from the plurality of clusters and weighing the plurality of clusters by similarity to the incoming query data.

In one embodiment, the training computer program may be further configured to hash the training dataset into a plurality of arrays using locality sensitive hashing and to communicate the plurality of arrays to the deployment electronic device; wherein the model explanation computer program may be further configured to estimate the Shapley value by using kernel density estimation.

According to another embodiment, a method may include: (1) receiving, by a training computer program executed by a deployment electronic device, a trainable machine learning model; (2) reserving, by the training computer program, an amount of memory on the deployment electronic device; (3) receiving, by the training computer program, a plurality of training examples in a stream; (4) training, by the training computer program, the trainable machine learning model with the training examples; (5) storing, by the training computer program, some of the training examples in the amount of memory; (6) receiving, by the trainable machine learning model, an incoming data query; (7) generating, by the trainable machine learning model, a prediction for the incoming data query; and (8) estimating, by a model explanation computer program, a Shapley value for the prediction.

In one embodiment, the model explanation computer program estimates the Shapley value based on a similarity of the incoming data query to one of the plurality of training examples.

In one embodiment, the method may also include: initializing, by the training computer program, a plurality of centroid vectors in the amount of memory; and identifying, by the training computer program and for each training example, one of the plurality of centroid vectors that may be closest to the training example and updating the closest centroid vector with the training example; wherein the model explanation computer program estimates the Shapley value by identifying one of the plurality of centroid vectors that may be closest to the incoming data query.

In one embodiment, the method may also include: initializing, by the training computer program, a random number of vectors in the amount of memory as centroids; calculating, by the training computer program, a hash string for each centroid using locality sensitive hashing; hashing, by the training computer program, each of the plurality of training examples using locality sensitive hashing and identifying one of the plurality of centroids corresponding to the hash; wherein the model explanation computer program estimates the Shapley value by identifying one of the plurality of centroids that may be closest to the incoming data query.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for approximation of Shapley values in memory-constrained environments according to an embodiment;

FIG. 2 illustrates a method for approximation of Shapley values in memory-constrained environments according to an embodiment;

FIG. 3 illustrates a method for approximation of Shapley values in memory-constrained environments according to another embodiment;

FIG. 4 illustrates a method for approximation of Shapley values in memory-constrained environments according to another embodiment;

FIG. 5 illustrates a system for approximation of Shapley values in memory-constrained environments according to another embodiment;

FIG. 6 illustrates a method for approximation of Shapley values in memory-constrained environments according to an embodiment;

FIG. 7 illustrates a method for approximation of Shapley values in memory-constrained environments according to another embodiment;

FIGS. 8A and 8B illustrate a method for approximation of Shapley values in memory-constrained environments according to another embodiment;

FIG. 9 depicts an exemplary computing system for implementing aspects of the present disclosure.

### DETAILED DESCRIPTION OF PREFERRED EMBODIMENTS

Embodiments relate to systems and methods for approximation of Shapley values in memory-constrained environments.

Embodiments may approximate the Shapley values in two contexts: using a static model and a dynamic model. With the static model, the model is trained in an environment that has plentiful resources and is not constrained by memory or compute power. Model predictions, however, happen in a resource-scarce environment. As an example, a language model trained in a large mainframe or supercomputer may be deployed to personal workstations, kiosks, terminals, etc. which have very different computational resources available to them. Once the model is deployed, it is not changed or updated. To make Shapely value approximations, a small data structure may be used to make predication during inference.

Unlike the static model, a dynamic model is trained in a resource-scarce environment. Because of this, not all training data can be stored and only a small slice of data can be accepted at a time. Thus, the data is received as streaming data and the model is trained using continual learning. The constraint on memory also necessitates only a small memory footprint to make Shapley value predictions.

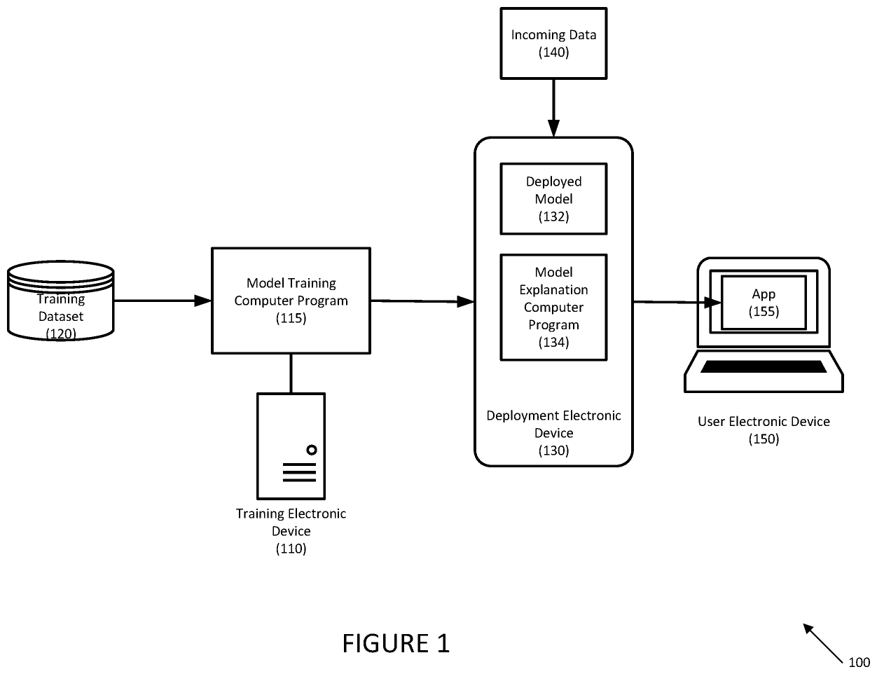

Referring to FIG. 1, a system for approximation of Shapley values in memory-constrained environments is disclosed according to an embodiment. System 100 may include, for example, training electronic device 110 which may be a supercomputer, a server (e.g., cloud and/or physical), a workstation, a desktop, etc. Training electronic device 110 may execute model training computer program 115, which may receive training dataset 120 and may train a machine learning model. The model may be a static model and may not be changed or updated once deployed to deployment electronic device 130.

The trained machine learning model may then be deployed as deployed model 132 in deployment electronic device 130, which may be an electronic device with less computational and/or memory resources than training electronic device 110. For example, deployment electronic device may be a computer (e.g., workstation, desktop, laptop, notebook, tablet, etc.), a smart device (e.g., smart phone), an Internet of Things (IoT) appliance, a kiosk, a terminal etc. Deployment electronic device 130 may receive incoming data query 140 and deployed model 132 may make a prediction based on incoming data query 140.

Deployment electronic device 130 may also execute model explanation computer program 134, which may make predictions on Shapley values for the output of deployed model 132. The Shapley value predictions may be output by deployment electronic device 130, or on application 155 executed by user electronic device 150, which may be a computer, a smart device, etc.

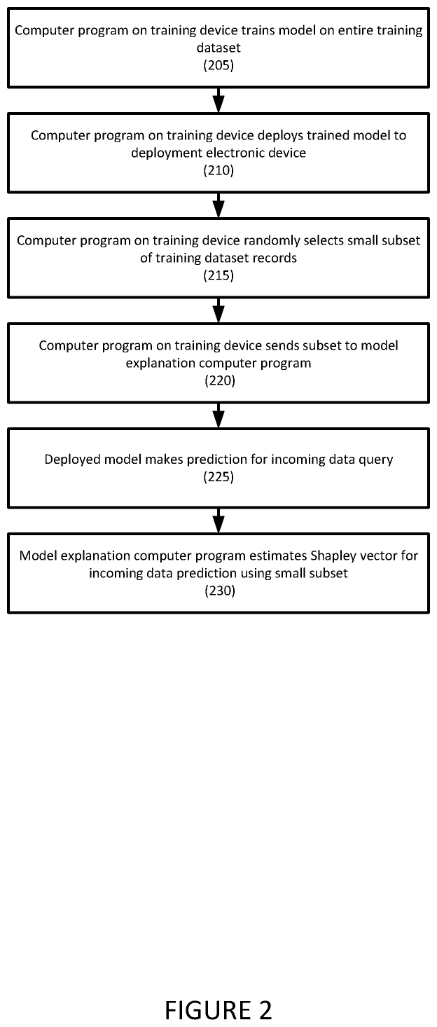

Referring to FIG. 2, a method for approximation of Shapley values in memory-constrained environments is disclosed according to an embodiment.

In step 205, a computer program on training device may receive a training dataset and may train a machine learning model on the entire training dataset. For example, in one embodiment, supervised training may be used.

In step 210, the computer program on the training device may deploy the trained model to a deployment electronic device.

In step 215, the computer program on training device may randomly select a small subset of training dataset records. In one embodiment, the size of the sample may be based on the memory available on the deployment electronic device.

In step 220, the computer program on the training device may send the subset to a model explanation computer program executed on the deployment electronic device.

In step 225, the deployed model may receive incoming data query and may make a prediction for the incoming data query.

In step 230, the model explanation computer program may estimate a Shapley value for the incoming data query prediction using the small subset. In one embodiment, the model explanation computer program may use kernel density estimation or the Nadaraya-Watson estimator, using the stored data structure, to calculate Shapley values. Examples of methods for estimating the Shapley value are disclosed in Aas et al., “Explaining individual predictions when features are dependent: More accurate approximations to Shapley values,” Artificial Intelligence 298 (2021): 103502, the disclosure of which is hereby incorporated, by reference, in its entirety.

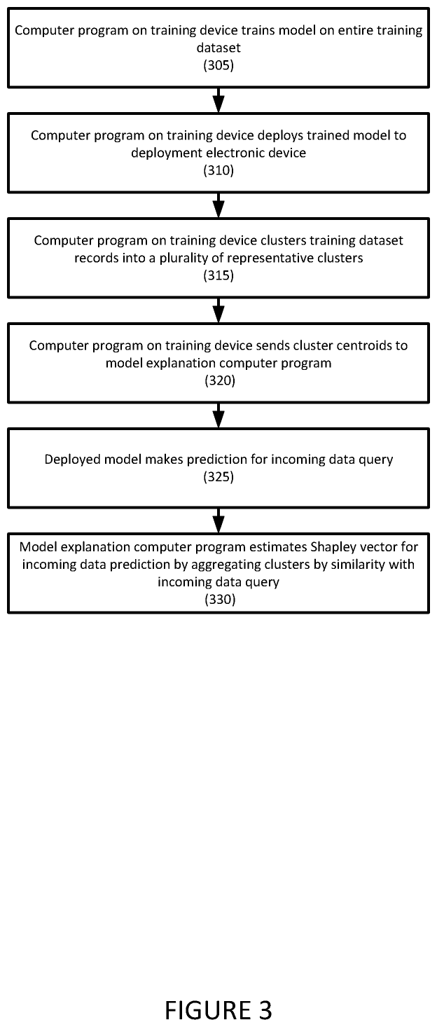

Referring to FIG. 3, a method for approximation of Shapley values in memory-constrained environments is disclosed according to another embodiment.

In step 305, a computer program on training device may receive a training dataset and may train a machine learning model on the entire training dataset. This may be similar to step 205, above.

In step 310, the computer program on the training device may deploy the trained model to a deployment electronic device.

In step 315, the computer program on training device may cluster training dataset records into a plurality of representative clusters. For example, the computer program may compress the training data using a clustering method, such as k-means clustering. The clustering may identify k datapoints that are representative of the entire training dataset.

In step 320, the computer program on the training device may send centroids of the k clusters to a model explanation computer program on the deployment electronic device.

In step 325, the deployed model may receive incoming data query and may make a prediction for the incoming data query.

In step 330, the model explanation computer program may estimate a Shapley value for the incoming data query prediction by aggregating the data from all clusters and by weighing the aggregated data by the similarity with incoming query data.

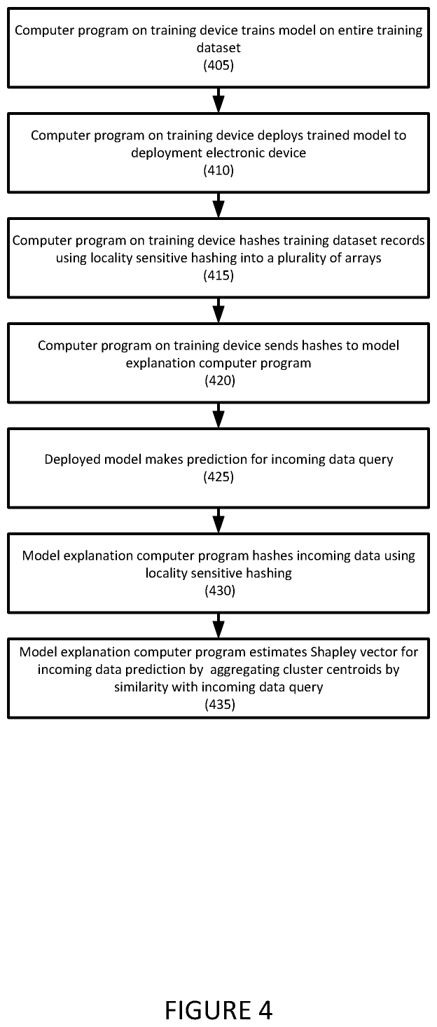

Referring to FIG. 4, a method for approximation of Shapley values in memory-constrained environments is disclosed according to another embodiment.

In step 405, a computer program on training device may receive a training dataset and may train a machine learning model on the entire training dataset. This may be similar to step 205, above.

In step 410, the computer program on the training device may deploy the trained model to a deployment electronic device.

In step 415, the computer program on the training device may hash the training dataset records using locality sensitive hashing, This may result in a plurality of arrays.

In step 420, the computer program on the training device may send the arrays to a model explanation computer program executed on the deployment electronic device.

In step 425, the deployed model may receive an incoming data query and may make a prediction for the incoming data query.

In step 430, the model explanation computer program may hash the incoming data query using locality sensitive hashing.

In step 435, the model explanation computer program may estimate a Shapley value for incoming data query prediction by using a kernel density estimator, such as the Nadarayab-Watson estimator, using the results of hashing.

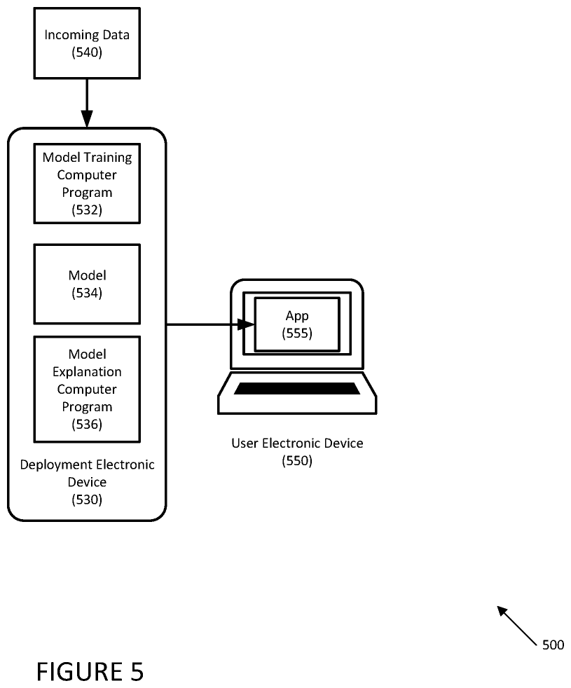

Referring to FIG. 5, a system for approximation of Shapley values in memory-constrained environments is disclosed according to an embodiment. System 500 may include, for example, deployment electronic device 530 which may be a computer (e.g., a workstation, a desktop, laptop, notebook, etc.), a kiosk, a terminal, etc. Deployment electronic device 530 may execute model training computer program 532, which may receive incoming data query 540 that may be used to continuously train machine learning model 534. Model 534 may be a dynamic model that is updated as incoming data query 540 is received. Model 534 may also make a prediction based on incoming data query 540.

Deployment electronic device 530 may further execute model explanation computer program 536, which may make predictions on Shapley values for the output of model 534. The Shapley value predictions may be output by deployment electronic device 530, or on application 555 executed by user electronic device 550, which may be a computer, a smart device, etc.

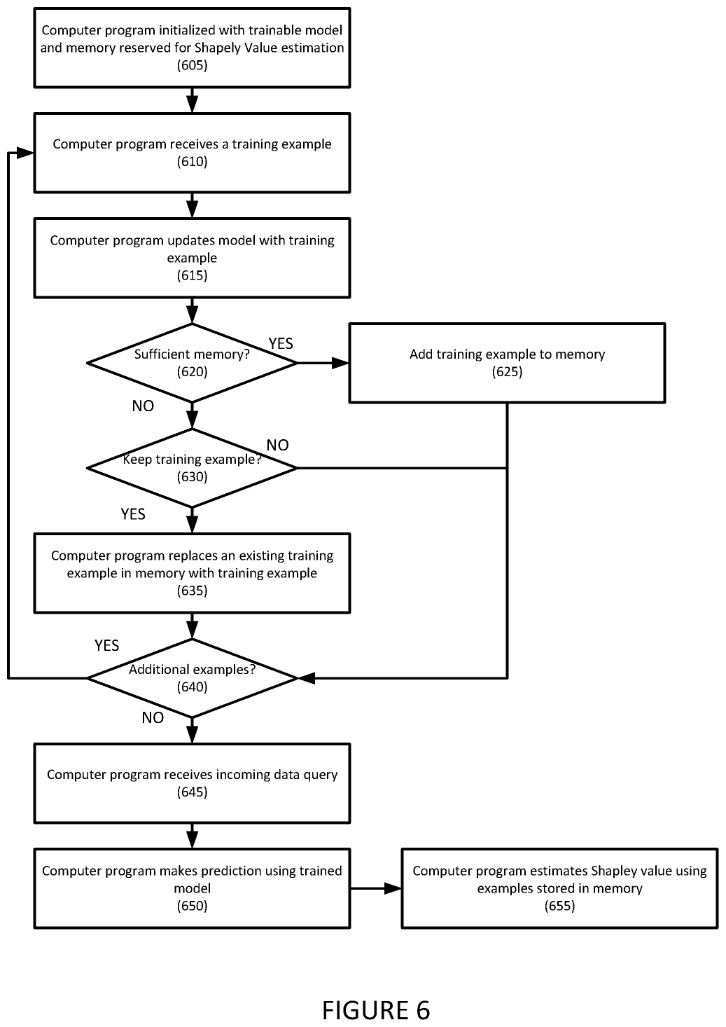

Referring to FIG. 6, a method for approximation of Shapley values in memory-constrained environments is disclosed according to an embodiment.

In step 605, a computer program executed by a deployment electronic device may be initialized with a trainable model. A certain amount of device memory may be reserved for Shapely Value estimation.

In step 610, the computer program may receive a training example in, for example, a streaming data flow.

In step 615, the computer program may update the trainable model with the training example. This may be done using any suitable training technique.

In step 620, the computer program may check to see if there is sufficient memory to store the training example. If there is, in step 625, the training example may be added to memory.

If there is insufficient memory to store the training example, in step 630, the computer program may determine whether the training example should be kept. In one embodiment, the determination on keeping the training example may be a random decision. In another embodiment, the determination may be random with a fixed turnover probability which may be a parameter. If the training example is to be kept, in step 635, the computer program may replace one of the existing training examples in memory the training example. The existing training example may be randomly selected.

In step 640, the computer program may determine if there are additional training examples available. If there are, the process may return to step 610. If there are not, training may be complete.

In step 645, the computer program may receive an incoming data query.

In step 650, using the trained mode, the computer program may make a prediction for the incoming data query.

In step 655, the computer program may estimate a Shapley value for the prediction for the incoming data query using examples stored in memory. For example, the computer program may calculate how similar the incoming data query is to all existing examples, and may aggregate the results using the similarity scores.

The computer program may then output the Shapley value.

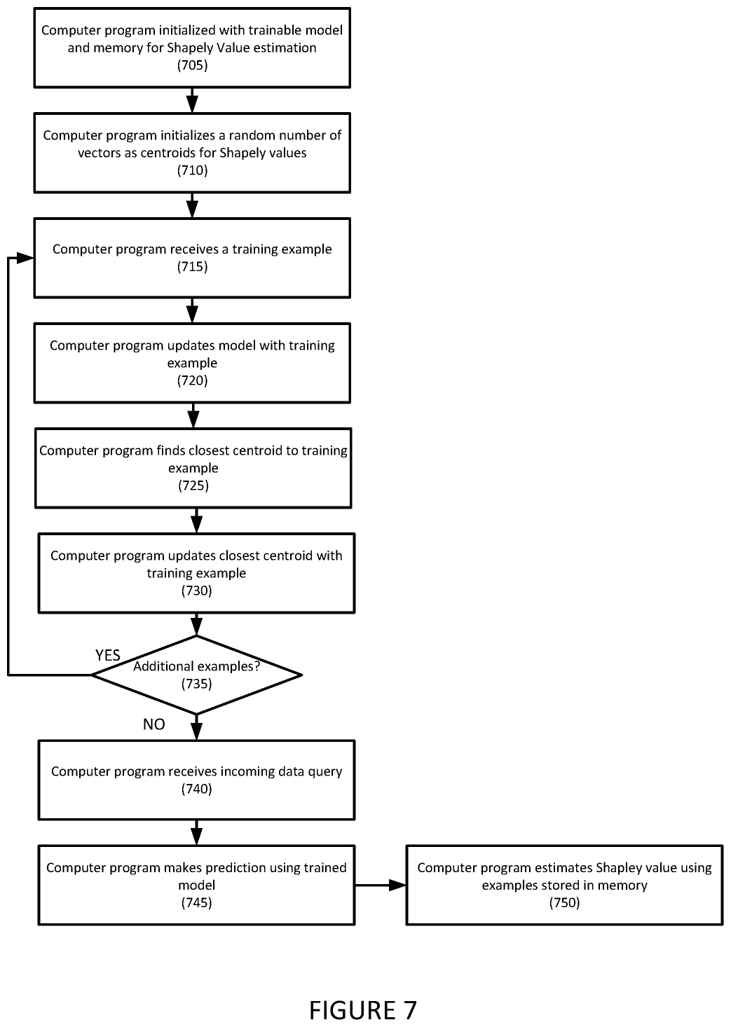

Referring to FIG. 7, a method for approximation of Shapley values in memory-constrained environments is disclosed according to an embodiment.

In step 705, a computer program executed by a deployment electronic device may be initialized with a trainable model. A certain amount of device memory may be initialized for Shapely Value estimation.

In step 710, the computer program may initialize a random number of vectors as centroids for Shapely vector values. The number of vectors may be limited by the amount of memory that is available for Shapley value estimation.

In one embodiment, each centroid vector may be generated by sampling each element of the vector from a standard normal distribution.

In step 715, the computer program may receive a training example in, for example, a streaming data flow.

In step 720, the computer program may update the trainable model with the training example. This may be done using any suitable training technique.

In step 725, the computer program may find the closest centroid to the training example, and in step 730, may update the closest centroid with the training example. In one embodiment, the closest centroid may be identified by measuring a distance (e.g., the Euclidean distance) between the query and all the centroids.

The centroid may be updated by 1/m (centroid—training example) where m is the number of examples previously assigned to the centroid.

In step 735, the computer program may determine if there are additional training examples available. If there are, the process may return to step 715. If there are not, training may be complete.

In step 740, the computer program may receive an incoming data query.

In step 745, using the trained model, the computer program may make a prediction for the incoming data query.

In step 750, the computer program may estimate a Shapley value for the prediction by finding the centroid stored in memory that is closest to the received examples stored in memory. For example, embodiments may use a kernel density estimator, such as the Nadarayab-Watson estimator.

The computer program may then output the Shapely vector value.

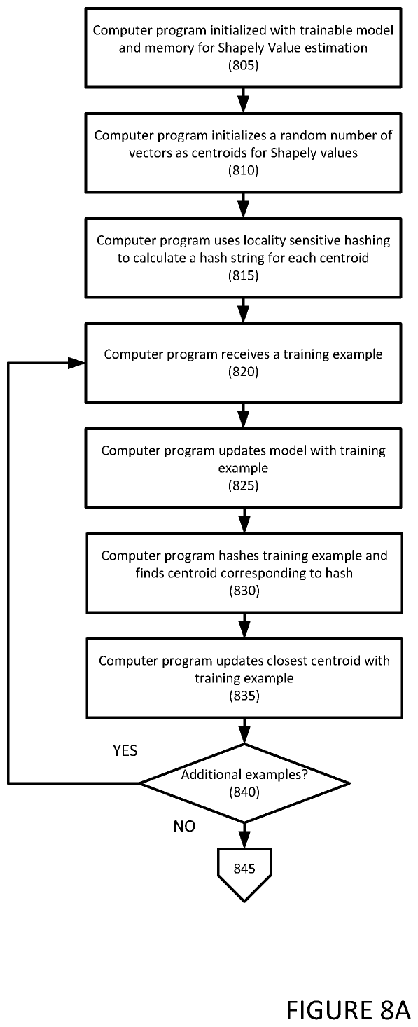

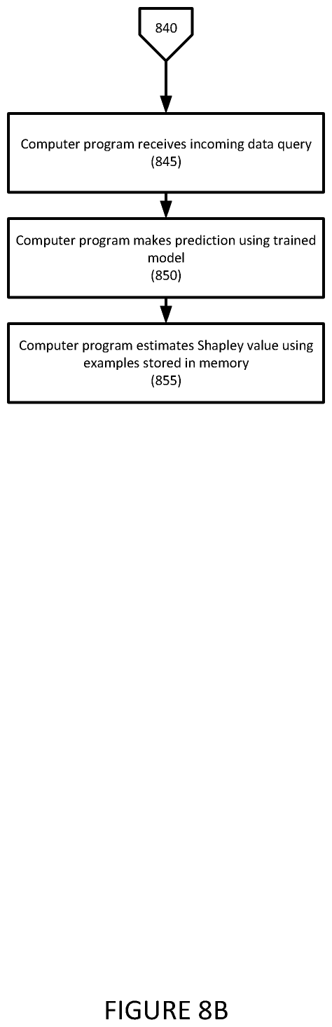

Referring to FIGS. 8A and 8B, a method for approximation of Shapley values in memory-constrained environments is disclosed according to an embodiment.

In step 805, a computer program executed by a deployment electronic device may be initialized with a trainable model. A certain amount of device memory may be initialized for Shapely Value estimation.

In step 810, the computer program may initialize a random number of vectors as centroids for Shapely vector values. This may be similar to step 710, above.

In step 815, the computer program may use locality sensitive hashing to calculate a hash string for each centroid.

In step 820, the computer program may receive a training example in, for example, a streaming data flow.

In step 825, the computer program may update the trainable model with the training example. This may be done using any suitable training technique.

In step 830, the computer program may hash the training example using locality sensitive hashing and may find a centroid corresponding to the hash. In step 835, the computer program may update the closest centroid with the training example.

In step 840, the computer program may determine if there are additional training examples available. If there are, the process may return to step 820. If there are not, training may be complete.

In step 845, the computer program may receive an incoming data query.

In step 850, using the trained model, the computer program may make a prediction for the received example.

In step 855, the computer program may estimate a Shapley value for the prediction by aggregating centroids by their similarity with the query. For example, embodiments may use a kernel density estimator, such as the Nadarayab-Watson estimator.

The computer program may then output the Shapely vector value.

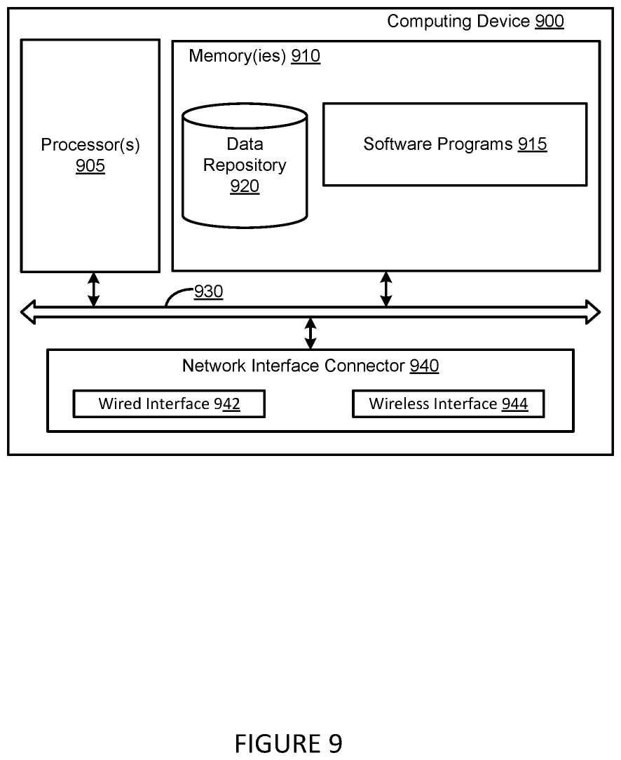

FIG. 9 depicts an exemplary computing system for implementing aspects of the present disclosure. FIG. 9 depicts exemplary computing device 900. Computing device 900 may represent the system components described herein. Computing device 900 may include processor 905 that may be coupled to memory 910. Memory 910 may include volatile memory. Processor 905 may execute computer-executable program code stored in memory 910, such as software programs 915. Software programs 915 may include one or more of the logical steps disclosed herein as a programmatic instruction, which may be executed by processor 905. Memory 910 may also include data repository 920, which may be nonvolatile memory for data persistence. Processor 905 and memory 910 may be coupled by bus 930. Bus 930 may also be coupled to one or more network interface connectors 940, such as wired network interface 942 or wireless network interface 944. Computing device 900 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a training computer program executed on a training electronic device, a training dataset;
training, by the training computer program, a machine learning model on the training dataset;
deploying, by the training computer program, the machine learning model to a deployment electronic device;
receiving, by the deployment electronic device, an incoming data query;
generating, using the machine learning model, a prediction for the incoming data query; and
estimating, by a model explanation computer program, a Shapley value for the prediction.

2. The method of claim 1, further comprising:
selecting, by the training computer program, a subset of the training dataset; and
communicating, by the training computer program, the subset to the model explanation computer program,
wherein the model explanation computer program estimates the Shapley value using kernel density estimation.

3. The method of claim 1, further comprising:
clustering, by the training computer program, the training dataset into a plurality of clusters; and
communicating, by the training computer program, centroids for the plurality of clusters to the deployment electronic device;
wherein the model explanation computer program estimates the Shapley value by aggregating data from the plurality of clusters and weighing the plurality of clusters by similarity to the incoming query data.

4. The method of claim 1, further comprising:
hashing, by the training computer program, the training dataset into a plurality of arrays using locality sensitive hashing; and
communicating, by the training computer program, the plurality of arrays to the deployment electronic device;
wherein the model explanation computer program estimates the Shapley value by using kernel density estimation.

5. A system, comprising:
a training electronic device comprising a first computer processor and executing a training computer program; and
a deployment electronic device comprising a second computer processor and executing a model explanation computer program;
wherein the training computer program is configured to receive a training dataset, to train a machine learning model on the training dataset, to deploy the machine learning model to a deployment electronic device;
the deployment electronic device is configured to receive an incoming data query, to generate, using the machine learning model, a prediction for the incoming data query;
the model explanation computer program is configured to estimating a Shapley value for the prediction.

6. The system of claim 5, wherein the training computer program is further configured to select a subset of the training dataset and to communicate the subset to the model explanation computer program; and
wherein the model explanation computer program is further configured to estimate the Shapley value using kernel density estimation.

7. The system of claim 5, wherein the training computer program is further configured to cluster the training dataset into a plurality of clusters, and to communicate centroids for the plurality of clusters to the deployment electronic device;
wherein the model explanation computer program is further configured to estimate the Shapley value by aggregating data from the plurality of clusters and weighing the plurality of clusters by similarity to the incoming query data.

8. The system of claim 5, wherein the training computer program is further configured to hash the training dataset into a plurality of arrays using locality sensitive hashing and to communicate the plurality of arrays to the deployment electronic device;
wherein the model explanation computer program is further configured to estimate the Shapley value by using kernel density estimation.

9. A method, comprising:
receiving, by a training computer program executed by a deployment electronic device, a trainable machine learning model;
reserving, by the training computer program, an amount of memory on the deployment electronic device;
receiving, by the training computer program, a plurality of training examples in a stream;
training, by the training computer program, the trainable machine learning model with the training examples;
storing, by the training computer program, some of the training examples in the amount of memory;
receiving, by the trainable machine learning model, an incoming data query;
generating, by the trainable machine learning model, a prediction for the incoming data query; and
estimating, by a model explanation computer program, a Shapley value for the prediction.

10. The method of claim 9, wherein the model explanation computer program estimates the Shapley value based on a similarity of the incoming data query to one of the plurality of training examples.

11. The method of claim 9, further comprising:
initializing, by the training computer program, a plurality of centroid vectors in the amount of memory; and
identifying, by the training computer program and for each training example, one of the plurality of centroid vectors that is closest to the training example and updating the closest centroid vector with the training example;
wherein the model explanation computer program estimates the Shapley value by identifying one of the plurality of centroid vectors that is closest to the incoming data query.

12. The method of claim 9, further comprising:
initializing, by the training computer program, a random number of vectors in the amount of memory as centroids;
calculating, by the training computer program, a hash string for each centroid using locality sensitive hashing; and
hashing, by the training computer program, each of the plurality of training examples using locality sensitive hashing and identifying one of the plurality of centroids corresponding to the hash;
wherein the model explanation computer program estimates the Shapley value by identifying one of the plurality of centroids that is closest to the incoming data query.
